(19) United States
(12) Patent Application Publication
(10) Pub. No.: US 2003/0127822 A1
(43) Pub. Date: Jul. 10, 2003

(54) Transportation device

(76) Inventors: Steven James Fleck, Camegic, PA (US); James Frederick Fleck, Camegic, PA (US)

Correspondence Address: Kent E. Baldauf, Jr., 700 Koppers Building, 436 Seventh Avenue, Pittsburgh, PA, 15219-1818, US

(21) Appl. No.: 10/338,460

(22) Filed: Jan. 8, 2003

Related U.S. Application Data
(60) Provisional application No. 60/345,647, filed on Jan. 8, 2002.

(51) Int. Cl. B62M 1/02

(52) U.S. Cl. 280/259

(57) ABSTRACT

A transportation device including a frame element with a first and second end. A first wheel element is rotatably connected to the frame element first end and contacts a supporting surface, and a second wheel element is rotatably connected to the frame element second end and also contacts the supporting surface. A crank axle is rotatably attached to the frame element and includes crank elements attached thereto and extending radially outward therefrom in opposite directions. The crank axle is in rotational communication with the second wheel element and serves to rotate the second wheel element. First and second pedal elements are rotatably attached to the crank elements and, in operation, move in a substantially elliptical path.

### CROSS REFERENCE TO RELATED APPLICATIONS

This application claims priority from U.S. Provisional Patent Application Serial No. 60/345,647, filed Jan. 8, 2002.

### BACKGROUND OF THE INVENTION

1. Field of the Invention

The present invention relates generally to transportation devices, such as bicycles and the like, and, in particular, to transportation devices driven by pedals moving in an elliptical path.

2. Description of Related Art

As exercising is beneficial to one's health and prolongs life, it has become a popular pastime and includes many and varying means for exercising various parts of the body. For example, in order to both work out the muscles in the legs as well as increase aerobic activity, exercise machines have been developed. In order to further increase the user's workout and simulate a running or jogging motion, exercise machines have also been developed that allow the users to move their feet in an elliptical path, which increases muscular development.

Typical elliptical exercise machines have the user standing in a fixed position on pedal arms, with his or her feet moving in an elliptical pattern, as viewed from the side of the machine. This motion simulates a walking or running motion, yet provides continuous foot and leg support for the user to minimize detrimental foot and leg impact. Such elliptical machines are built on frames that are always stationary with respect to the ground, when. in use. For example, both U.S. Pat. No. 6,190,289 to Pyles et al. and U.S. Pat. No. 6,063,008 to McBride et al. disclose stationary elliptical motion exercise machines.

However, as such, many users prefer to be outdoors when performing their exercise routines. Alternatively, a user may wish to transport him or herself to various locations, while, at the same time, gaining useful exercise time. Typical scooters, bicycles and the like allow a person to be both outdoors, as well as serve as a transport device. Such scooters and bicycles have pedals that allow a user to mobilize the device and move from location to location. For example, U.S. Pat. No. 5,192,089 to Taylor is directed to a pedal-operated scooter, where the pedals move up and down. Similarly, U.S. Pat. No. 5,224,724 to Greenwood also discloses a scooter with a simple harmonic drive, where the user pushes the pedals in an up-and-down manner. Finally, U.S. Pat. No. 4,779,863 is directed to a running exercise bicycle, where the user can use two separate and independent pedals to move the bicycle in a zigzag or straight path.

Presently, it is desirable for a user to perform this elliptical-motion exercise with a non-stationary or transportation device. This is desired so that the user can perform this type of exercise outdoors and while simulating the experience of running or jogging. In addition, the user may wish to perform this type of exercise while traversing a distance from location to location.

While the above-described scooters and bicycles allow a user to move from location to location, the user does not gain the benefits offered by an elliptical exercise machine. In addition, a user may wish to perform this type of exercise in a standing, as opposed to a sitting, position, as is currently offered on bicycles and other typical modes of transportation.

### SUMMARY OF THE INVENTION

It is, therefore, an object of the present invention to provide a transportation device that overcomes the deficiencies of the prior art. It is another object of the present invention to provide a transportation device that allows a user to motivate the device via pedals, which allow the user to move his or her feet in an elliptical motion. It is a still further object of the present invention to provide a transportation device that can be used outdoors and move a user from location to location as a means of transport.

Accordingly, a transportation device is provided. This transportation device includes a frame element with a first and second end. A first wheel element is rotatably connected to the frame element first end and contacts a supporting surface, such as the ground. A second wheel element is connected to the frame element second end and also contacts the supporting surface. A crank axle is rotatably attached to the frame element and includes a first and second crank element, each with a first end fixedly attached to the crank axle and extending radially outward from the crank axle in a substantially opposite direction with respect to each other. The crank axle is in rotational communication with either the first wheel element or the second wheel element, and rotation of the crank axle imparts proportional rotation to either the first wheel element or the second wheel element. A first and second pedal element are rotatably attached to a respective second end of the first and second crank element. In operation, the first and second pedal elements move in a substantially elliptical path, thus motivating or moving the transportation device along the supporting surface.

The present invention, both as to its construction and its method of operation, together with the additional objects and advantages thereof, will best be understood from the following description of exemplary embodiments when read in connection with the accompanying drawings.

### BRIEF DESCRIPTION OF THE DRAWINGS

FIG. 1 is a side view of a transportation device according to the present invention;

FIG. 2 is a side view of the transportation device of FIG. 1, excluding the first and second wheel elements;

FIG. 3 is a side view of the frame of the transportation device of FIG. 1;

FIG. 4 is a partial top view of a portion of the frame taken along section A-A;

FIG. 5 is a side view of a pedal element of the transportation device according to FIG. 1; and

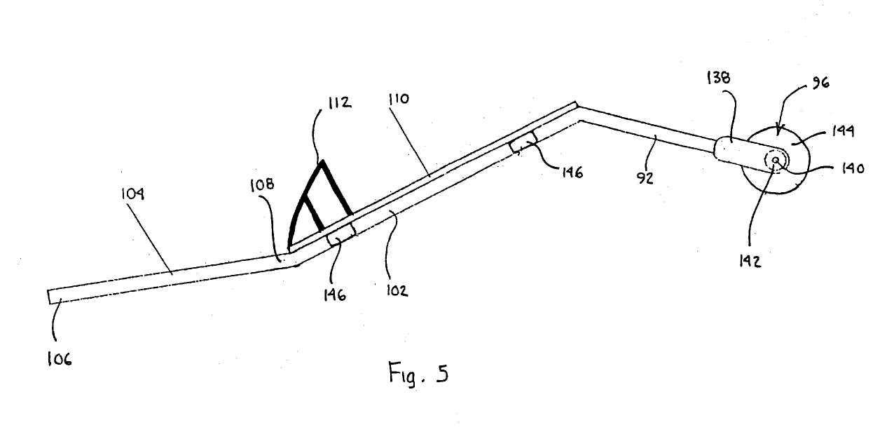

FIG. 6 is a top view of the pedal element of FIG. 5.

### DESCRIPTION OF THE PREFERRED EMBODIMENTS

For purposes of the description hereinafter, the terms “upper”, “lower”, “right”, “left”, “vertical”, “horizontal”, “top”, “bottom”, “forward”, “rear”, “rearward” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

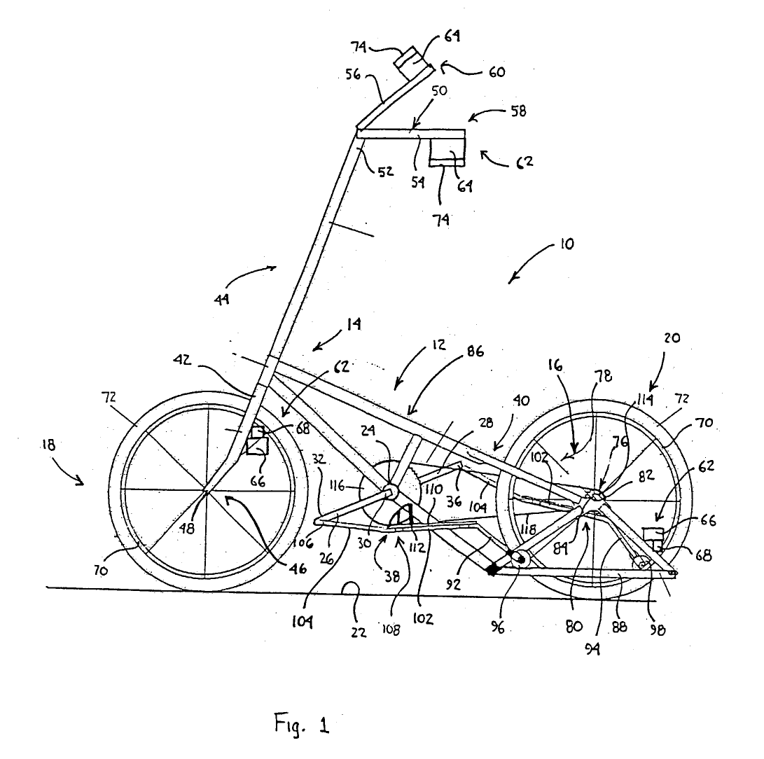

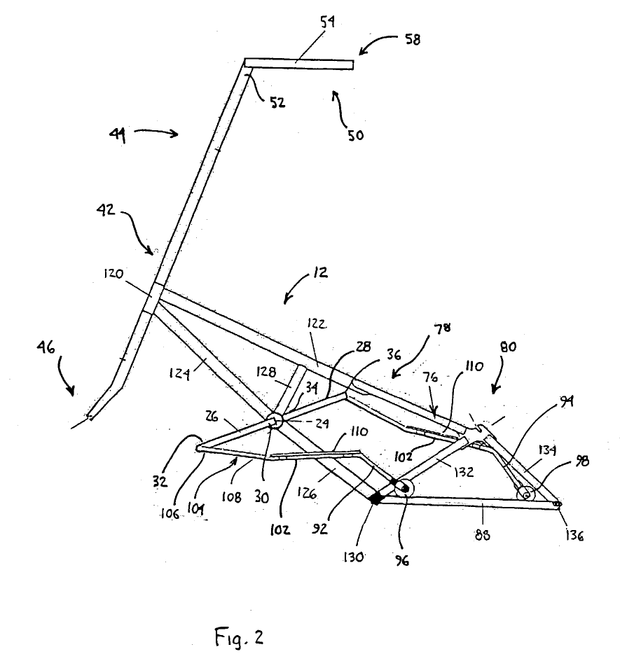

The present invention is a transportation device 10, as illustrated in FIGS. 1 and 2. This transportation device includes a frame element 12, with a frame element first end 14 and a frame element second end 16. A first wheel element 18 is rotatably connected to the frame element first end 14 and contacts a supporting surface 22, such as the ground, a road, a sidewalk, a path, etc. A second wheel element 20 is rotatably connected to the frame element second end 16 and also contacts the supporting surface 22.

A crank axle 24 is rotatably attached to the frame element 12 and, in a preferred and non-limiting embodiment, is in a substantially central location with respect to the first wheel element 18 and the second wheel element 20. The crank axle 24 includes a first crank element 26 and a second crank element 28. The first crank element 26 has a first crank element first end 30 and a first crank element second end 32. Similarly, the second crank element 28 includes a second crank element first end 34 and a second crank element second end 36. Both the first crank element first end 30 and the second crank element first end 34 are attached to the crank axle 24 and extend radially outward from the crank axle 24 in a substantially opposite direction with respect to each other.

The crank axle 24 is in rotational communication with one or both of the first wheel element 18 and the second wheel element 20. Therefore, rotation of the crank axle 24 imparts proportional rotation to one or both of the first wheel element 18 and the second wheel element 20. In a preferred and non-limiting embodiment, the crank axle 24 is in rotational communication with the second wheel element 20, which is typically positioned in the rear of the transportation device 10, and the crank axle 24 is surrounded by a bracket with an inner bearing surface, as is known in the art.

A first pedal element 38 and a second pedal element 40 are rotatably attached to the first crank element second end 32 and the second crank element second end 36 respectively. Due to the positioning of the first pedal element 38 and the second pedal element 40 with respect to the crank axle 24, in operation, the first pedal element 38 and the second pedal element 40 move in a substantially elliptical path during rotation.

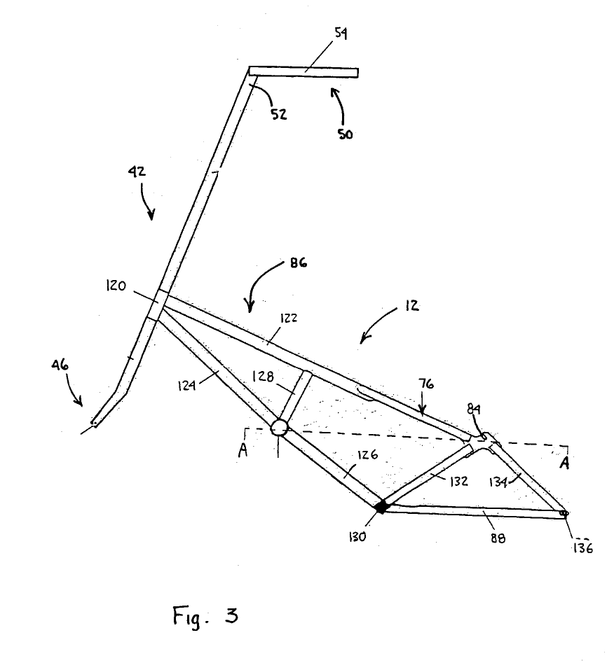

In a preferred embodiment, as seen in FIGS. 1-3, the frame element 12 includes a first fork element 42 having a first fork element first end 44 and a first fork element second end 46. The first fork element first end 44 is rotatably attached to the frame element first end 14. A first wheel axle 48 is rotatably attached to the first fork element second end 46, and the first wheel element 18 is fixedly attached to the first wheel axle 48. In this embodiment, the frame element 12 also includes a handlebar 50 fixedly attached to the first fork element first end 44. This allows a user to rotate the first fork element 42, which, in turn, rotates the first wheel element 18. In this manner, the user is able to steer the transportation device 10 in a desired direction. As discussed above in connection with the crank axle 24, the first wheel axle may include a bracket and/or an inner bearing surface or element.

The handlebar 50 is preferably substantially T-shaped, with a handlebar central leg 52 extending from a central portion of the handlebar 50 and attached to the first fork element first end 44. In addition, a handlebar first arm 54 and a handlebar second arm 56 extend from the central portion in a substantially opposite direction from each other. Each of the handlebar first arm 54 and the handlebar second arm 56 include a handlebar first arm free end 58 and a handlebar second arm free end 60. In a preferred embodiment, both the handlebar first arm free end 58 and the handlebar second arm free end 60 are partially or wholly surrounded by a pliant padding material, preferably in the form of a grip. This will allow the user to easily grasp the handlebar 50 and rotate the handlebar 50 in the desired direction.

The transportation device 10 may also include a braking mechanism 62. In a preferred embodiment, the braking mechanism 62 includes a handbrake mechanism 64 removably attached to the handlebar 50, typically on one or both of the handlebar first arm 54 and the handlebar second arm 56. In this embodiment, the braking mechanism 62 would also include a wheel brake mechanism 66 having a pad element 68 in operable communication with the first wheel element 18 and/or the second wheel element 20. The pad element 68 is used to resist rotation of the first wheel element 18 and/or the second wheel element 20 via frictional engagement between the pad element 68 and the respective first wheel element 18 and/or the second wheel element 20.

In a preferred embodiment, the braking mechanism 62 includes two handbrake mechanisms 64, with one handbrake mechanism 64 located on or adjacent the handlebar first arm free end 58 and a second handbrake mechanism 64 located on or adjacent the handlebar second arm free end 60. Each handbrake mechanism 64, when activated, would resist movement in a respective first wheel element 18 and second wheel element 20. Further, the respective handbrake mechanism 64 is typically connected to the respective wheel brake mechanism 66 via a cable (not shown), which provides a tensioning mechanism and communication between the various components of the braking mechanism 62, as is well known in the art.

The first wheel element 18 and the second wheel element 20 typically include a rim 70 with an outer recess (not shown) for receiving a tire 72. The pad element 68 of the wheel brake mechanism 66 is in operable communication and allowed to frictionally engage the rim 70 of either the first wheel element 18 or the second wheel element 20. The handbrake mechanism 64 typically includes a hand lever 74, such that pivoting of the hand lever 74 forces the pad element 68 to incrementally increase contact with the first wheel element 18 or the second wheel element 20, and specifically the respective rim 70.

The frame element 12 also includes a second fork element 76, with a second fork element first end 78 and a second fork element second end 80. The second fork element first end 78 is fixedly attached to the frame element second end 16, and a second wheel axle 82 is rotatably attached to the second fork element second end 80 (such as by a bracket and/or bearing surface as discussed above). The second wheel element 20 is then fixedly attached to the second wheel axle 82. This allows the second wheel element 20 to spin or rotate with respect to the frame element 12. In a preferred embodiment, the second fork element 76 includes a slot 84, which allows the slot 84 to slidably receive the second wheel axle 82. This slot 84 is oriented in an opposite direction than that found on a standard bicycle as known in the art. The orientation of the slot 84 allows the user to easily remove the second wheel element 20 without disassembling any portion of the frame element 12.

The frame element 12 typically is manufactured by multiple sectional tubular elements 86. These tubular elements 86 are manufactured from a metal, a semi-metal, a plastic, and/or a polymeric material. As is known in the art, these sectional tubular elements 86 are typically made from an inexpensive, yet lightweight, metal material.

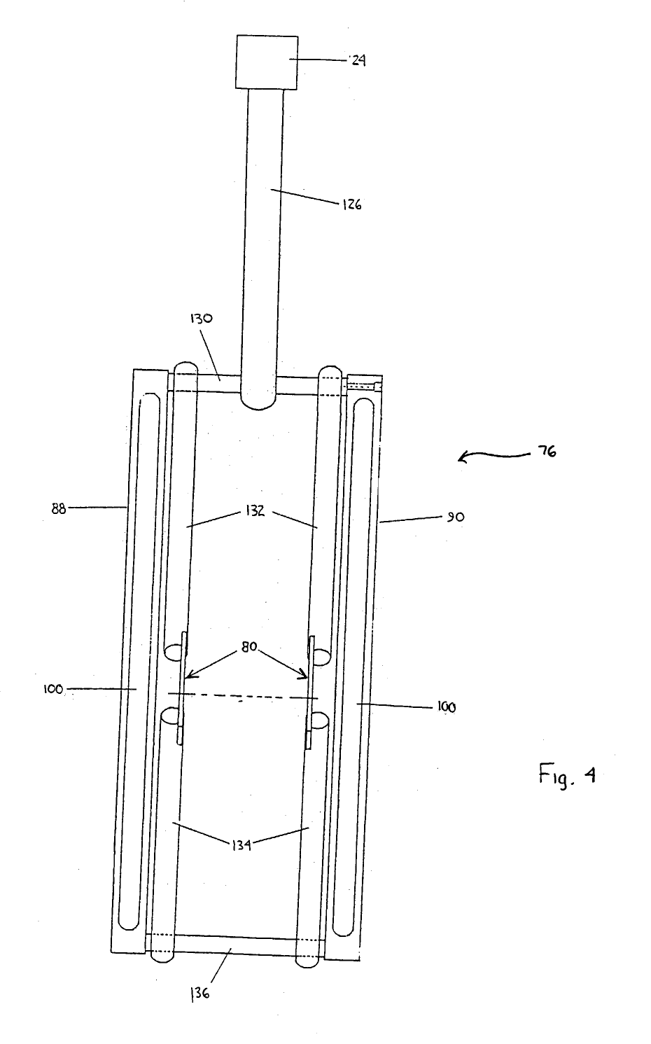

In order to provide overall support and stability to the transportation device 10, in a preferred and non-limiting embodiment, the frame element 12 also includes a first track element 88 and a second track element 90. As best seen in FIG. 4, the first track element 88 and the second track element 90 are attached to the frame element second end 16. Further, the first track element 88 and the second track element 90 extend in a direction substantially parallel to the second wheel element 20 and on opposite sides of the second wheel element 20. A first rearward pedal extension 92 is fixedly attached to and extends from the first pedal element 38 and terminates in a first rotatable roller 96. Similarly, a second rearward pedal extension 94 is fixedly attached to and extends away from the second pedal element 40 and terminates in a second rotatable roller 98. Each of the first rotatable roller 96 and the second rotatable roller 98 contact and move in a substantially lateral path along the respective first track element 88 and the second track element 90.

In order to enhance the engagement between the rotatable roller (96, 98) and the track element (88, 90), each of the first track element 88 and the second track element 90 may also include a roller groove 100 sized and shaped so as to at least partially receive a respective rotatable roller (96, 98) therein. Since the first pedal element 38 is connected to the first crank element 26, and the second pedal element 40 is connected to the second crank element 28, the resulting structure provides overall support to the crank elements (26, 28) and the pedal elements (38, 40) when in operation.

In the preferred embodiment, the first pedal element 38 and the second pedal element 40 include a central pedal portion 102 and a front pedal extension 104 having a front pedal extension first end 106 and a front pedal extension second end 108. The front pedal extension first end 106 is rotatably attached to the first crank element 26, and the front pedal extension second end 108 is attached to the central pedal portion 102. In this manner, the crank axle 24 is connected to the rotatable rollers (96, 98) through the resulting linkage, namely a respective front pedal extension 104, central pedal portion 102, rearward pedal extension (92, 94) and rotatable roller (96, 98).

In a preferred embodiment, the central pedal portion 102 includes a pedal pad 110, which allows a user to place his or her foot on the pedal pad 110 to motivate the respective pedal element (38, 40). This pedal pad may also include a retention strap 112 attached to an upper and forward surface of the pedal pad 110. This retention strap 112 is sized and shaped so as to at least partially receive a front portion of a human foot therein. This further secures the user's foot to the pedal pad 110 and allows easier movement of the crank elements (26, 28). The pedal pad 110 may be manufactured from a rigid or pliant material, and may include a frictional gripping surface to reduce slippage of the user's foot.

In order to move the transportation device 10 in one preferred embodiment, the second wheel axle 82 includes a rear gear element 114 in communication with the second wheel axle 82, and the crank axle 24 includes a crank gear element 116 fixedly attached to the crank axle 24. Extending circumferentially around the crank gear element 116 and the rear gear element 114 is a chain 118. Therefore, rotation of the crank axle 24 rotates the crank gear element 116, which rotates the chain 118 and imparts proportional rotation to the rear gear element 114. It is also envisioned that either the crank gear element 116 and/or the rear gear element 114 include multiple gear plates (not shown) and a switching mechanism (not shown), which would enable a user to switch between the plurality of gear plates. This would allow the user to switch between gears using the switching mechanism, as is commonly known in the art. The switching mechanism may include a switching actuator operable by a user to switch between gear plates, thereby switching “speeds” of the transportation device 10.

As best seen in FIG. 2, the frame element 12 may also include a headset 120 attached to the frame element first end 14. The first fork element first end 44 would extend up through the headset 120 and further extend and connect with the handlebar 50. The headset 120 allows for easy rotation, via the handlebar 50, of the first wheel element 18. The frame element 12 may also include a top tube extending in a downward angle between the headset 120 and the second fork element first end 78. The bottom portion of the frame element 12 consists of two sections, the front bottom tube 124 and the rear bottom tube 126. The front bottom tube 124 and the rear bottom tube 126 are joined at or adjacent the crank axle 24 (or to a supporting bracket surrounding the crank axle 24). A support tube 128 extends up from this juncture and is attached to the top tube 122, thereby rigidly joining the upper and lower portions of the frame element 12.

When using the track elements (88, 90), the frame element 12 also includes a front track support tube 130 connected to the rear bottom tube 126. The front track support tube 130 extends in both directions and perpendicular to the plane of the top tube 122, front bottom tube 124 and rear bottom tube 126. On either side of the front track support tube 130, a front track support bar 132 extends upward and rearward towards the second wheel axle 82. The rearward end of the front track support bar 132 is joined to the second fork element 76.

The second fork element 76 is also rigidly attached to a rear track support bar 134, which extends rearward and downward to a rear track support tube 136. Both the front track support tube 130 and the rear track support tube 136 extend laterally beyond the respective front track support bar 132 and rear track support bar 134. It is these extended areas that allow for attachment of a respective track element (88, 90). Any manner of connections is envisioned, such as pinned connection, welding, etc.

The crank axle 24 may include a crank axle bearing through which an axle extends laterally. Further, any means of motivating the transportation device 10 is envisioned, as long as the pedal element (38, 40) moves in an elliptical pattern or motion with respect to the crank axle 24.

The length and respective angles of the first rearward pedal extension 92, the second rearward pedal extension 94, the central pedal portion 102 and the front pedal extension 104 are chosen to optimize the user's foot positioning during use of the transportation device 10. It is also envisioned that a roller bracket 138 is connected to each respective rearward pedal extension (92, 94). Further, each rotatable roller (94, 96) is attached to the roller bracket 138 via a roller pin 140, which is surrounded by a roller bearing 142. The roller bearing 142 is surrounded by a roller wheel 144 and is free to rotate about the roller pin 140. Of course, any manner of allowing the rotatable roller (94, 96) to rotate is envisioned.

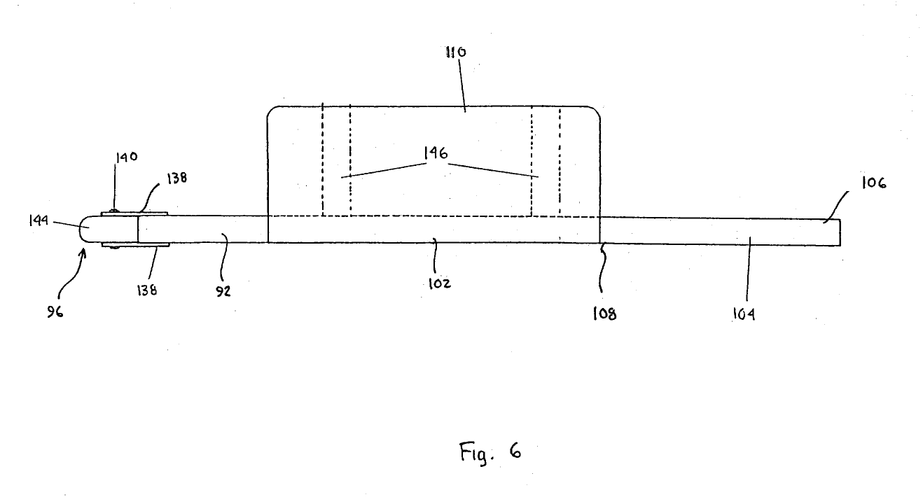

Referring to FIG. 6, the pedal pad 110 may also be offset from the central pedal portion 102. When in this position, the pedal elements (38, 40) may also include one or more pedal supports 146 for supporting the pedal pad 110. In the present embodiment, two pedal supports 146 are used and are rigidly connected to the central pedal portion 102.

In this manner, the present invention provides a transportation device 10 that allows a user to perform elliptical motion exercises using a pedaled transportation device 10. More beneficially, however, is that the transportation device 10 allows the user to perform the elliptical motion exercise while motivating the device 10 from location to location.

This invention has been described with reference to the preferred embodiments. Obvious modifications and alterations will occur to others upon reading and understanding the preceding detailed description. It is intended that the invention be construed as including all such modifications and alterations.

The invention claimed is:

1. A transportation device, comprising:
a frame element having a first end and a second end;
at least one first wheel element rotatably connected to the frame element first end and configured to contact a supporting surface;
at least one second wheel element rotatably connected to the frame element second end and configured to contact a supporting surface;
a crank axle rotatably attached to the frame element and having a first and second crank element, each with a first end fixedly attached to the crank axle and extending radially outward from the crank axle in a substantially opposite direction with respect to each other, the crank axle in rotational communication with at least one of the first wheel element and the second wheel element, whereby rotation of the crank axle imparts proportional rotation to the at least one first wheel element and second wheel element;
a first and a second pedal element rotatably attached to a respective second end of the first and second crank element;
wherein, in operation, the first and second pedal elements move in a substantially elliptical path.

2. The transportation device of claim 1, wherein the frame element further comprises a first fork element, with a first end and a second end, the first end of the first fork element rotatably attached to frame element first end, and a first wheel axle rotatably attached to the second end of the first fork element, wherein the at least one first wheel element is fixedly attached to the first wheel axle.

3. The transportation device of claim 2, wherein the frame element further comprises a handlebar fixedly attached to the first fork element first end and configured to rotate the fork element and at least one first wheel element.

4. The transportation device of claim 3, wherein the handlebar is substantially T-shaped, with a central leg extending from a central portion and attached to the fork element first end, and a first and second arm extending from the central portion in a substantially opposite direction and having a respective arm free end.

5. The transportation device of claim 4, wherein the free end of at least one of the first arm and the second arm is at least partially surrounded by a pliant padding material.

6. The transportation device of claim 3, further comprising a braking mechanism having a hand brake mechanism removably attached to the handlebar and wheel brake mechanism, having a pad element and in operable communication with at least one of the first wheel element and the second wheel element and configured to resist rotation of the one of the first wheel element and the second wheel element via frictional engagement between the pad element and the one of the first wheel element and the second wheel element.

7. The transportation device of claim 6, wherein at least one of the first wheel element and the second wheel element comprises a substantially circular rim with an outer recess and configured to receive a substantially circular tire, the pad element of the wheel brake mechanism in operable communication with the rim of the wheel element.

8. The transportation device of claim 6, wherein the hand brake mechanism includes a pivotal hand lever, and the pad element incrementally increases contact with the wheel element when the hand lever is pivoted in a first direction.

9. The transportation device of claim 1, wherein the frame element further comprises a second fork element, with a first end and a second end, the first end of the second fork element fixedly attached to frame element second end, and a second wheel axle rotatably attached to the second end of the second fork element, wherein the at least one second wheel element is fixedly attached to the second wheel axle.

10. The transportation device of claim 9, wherein the second fork element includes at least one slot configured to slidably receive the second wheel axle.

11. The transportation device of claim 1, wherein the frame element comprises a plurality of sectional tubular elements.

12. The transportation device of claim 11, wherein the sectional tubular elements are manufactured from one of a metal, a semi-metal, a plastic and a polymeric material.

13. The transportation device of claim 1, further comprising at least one track element attached to the frame element second end, at least one of the first pedal element and the second pedal element having a rearward pedal extension fixedly attached to and extending from the pedal element and terminating in a rotatable roller, wherein the rotatable roller is configured to contact and move substantially laterally along the track element as the pedal element is rotated.

14. The transportation device of claim 13, wherein the track element further comprises a roller groove extending along an upper surface of the track element and configured to at least partially receive the rotatable roller therein.

15. The transportation device of claim 13, further comprising a first track element and a second track element attached to the frame element and positioned on opposite sides of the second wheel element and extending substantially parallel with the support surface, each of the first pedal element and the second pedal element having a rearward pedal extension rigidly attached to and extending from the pedal element and terminating in a rotatable roller, wherein the rotatable roller of the first pedal element rearward pedal extension is configured to contact and move substantially laterally along the first track element as the first pedal is rotated and the rotatable roller of the second pedal element rearward pedal extension is configured to contact and move substantially laterally along the second track element as the second pedal is rotated.

16. The transportation device of claim 1, wherein the first pedal element and the second pedal element each further comprise a central pedal portion and a front pedal extension, with a first end and a second end, the first end of the front pedal extension rotatably attached to a respective crank element and the second end of the front pedal extension attached to the central pedal portion.

17. The transportation device of claim 16, wherein at least one of the central pedal element of the first pedal element and the second pedal element further includes a pedal pad configured to support a human foot.

18. The transportation device of claim 17, wherein the pedal pad is manufactured from one of rigid material and a pliant material and includes a frictional gripping surface.

19. The transportation device of claim 17, wherein the pedal pad further includes a retention strap attached to an upper and forward surface of the pedal pad and configured to at least partially receive a front portion of a human foot therein.

20. The transportation device of claim 1, further comprising a second wheel axle rotatably attached to the frame element second end and having a rear gear element in communication therewith, the crank axle having a crank gear element fixedly attached thereto, and a chain extending circumferentially around the crank gear element and the rear gear element, whereby rotation of the crank gear element rotates the chain and imparts proportional rotation to the rear gear element.

21. The transportation device of claim 20, wherein at least one of the crank gear element and the rear gear element comprise a plurality of gear plates and a switching mechanism configured to enable a user to switch between the plurality of gear plates.

22. The transportation device of claim 21, wherein the switching mechanism includes a switching actuator operable by a user to switch between gear plates.
